(19) United States
(12) Patent Application Publication
(10) Pub. No.: US 2010/0210307 A1
(43) Pub. Date: Aug. 19, 2010

(54) Telecommunication network server

(76) Inventor: Lionel Gervais, Lannion (FR)

Correspondence Address: HARNESS, DICKEY & PIERCE, P.L.C., P.O. BOX 8910, RESTON, VA, 20195, US

(21) Appl. No.: 12/656,005

(22) Filed: Jan. 13, 2010

(30) Foreign Application Priority Data
Jan. 16, 2009 (EP) 09305039.1

(51) Int. Cl. H04B 1/38

(52) U.S. Cl. 455/558

(57) ABSTRACT

The invention relates to a server (20) for a telecommunications network comprising at least a first card (30) and a second card (30′) equipped with elements managing transmissions transmitted or received by mobile terminals, this first card (30) and this second card (30′) each comprising a processor (21, 21′) and an interface (22, 22′) that may receive commands transmitted by an external controller to their card (30, 30′), characterized in that the processor (21) of the first card (30) is connected to the interface (22′) of the second card (30′) to enable control of the second card (30′) by the processor (21) of the first card.

The present invention relates to a telecommunication network server.

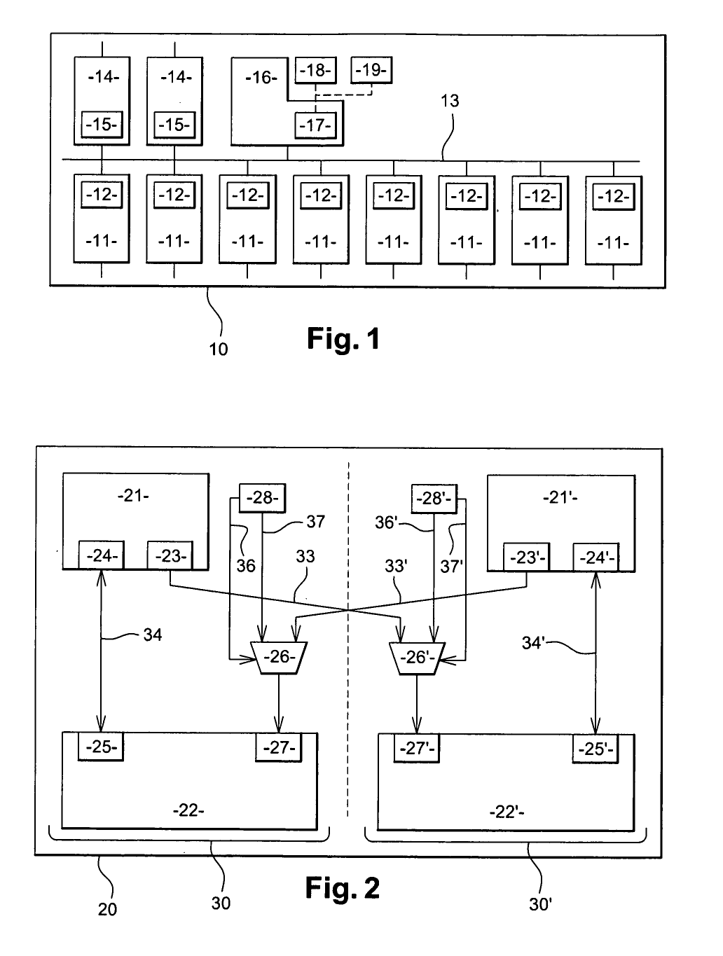

Using a server 10 (FIG. 1) is known for managing the establishment of communications between terminals, particularly mobile terminals. For this purpose, server 10 is equipped with a plurality of cards 11 comprising the components necessary for establishing these communications.

In order to develop compatibility between servers produced by different manufacturers, standards such as the ATCA (Advanced Telecom Computing Architecture) standards have been developed to define the architectures of such a server 10 equipped with a plurality of cards.

In the context of these ATCA standards, technical specifications such as the 3.0 R2.0 specification from the PICMG® (PCI Industrial Computer Manufacturers) Group requires server resource controllers 14 in order to, in particular, activate a card 11 held on standby when another card 11 presents a malfunction.

Through a bus 13, the controllers 14, also known as “Shelf Managers,” are connected to the cards 11 to, for example, be informed of their states and/or to control their operations.

This communication between controllers 14 and cards 11 is permitted by the use of a common language compliant with, for example, IPMI (Intelligent Platform Management Interface) specifications, which allow components such as a fan or a temperature probe to be monitored.

In this case, cards 11 comprise components 12, subsequently known as IPMC (Intelligent Platform Management Controllers) components, that may communicate via an IMPB (Intelligent Platform Management Bus) bus 13 with components 15 of controllers 14, also IPMI specification compliant.

Thus, interface 12 of each card 11 enables commands transmitted by an external controller 14 to the card to be transmitted to a processor, not represented, of this same card, this processor consequently controlling the elements of the card such as a fan or a probe.

In general, various server 10 elements may utilize the IPMB bus 13 to communicate. Similarly, components which do not have internal IPMI components, like power supplies 18 and 19 as well as an associated module 16, may share an IPMC interface 17 to control the power supply of cards 11.

The present invention results from the observation that the type of structure previously described, implementing controllers 14, presents a high cost when servers presenting a small number of cards, for example 2, have to be managed within a server.

In fact, the ratio between the cost of controllers and the cost of cards is acceptable when a high number, typically 14 or 16, of cards are managed in a server. However, this ratio becomes too high when the number of cards diminishes in a server typically presenting fewer than 10 cards.

This is why the present invention relates to a telecommunication network server comprising at least a first card and a second card equipped with elements managing transmissions from mobile terminals, this first card and second card each comprising a processor and an interface that may receive commands transmitted by an external controller to their card, characterized in that the processor of the first card is connected to the interface of the second card to enable the second card to be checked by the processor of the first card.

Thanks to the invention, it is possible to ensure that a card is checked within a server by the processor of another card from this server. Thus, the cost of a server is reduced by the absence of controllers dedicated to the operation of cards since the card processor is used as an external controller for another card.

In one embodiment, the processor of the first card comprises means to activate the second card in case of malfunction of the first card and means to maintain the second card on standby in case of correct operation of the first card.

According to one embodiment, the processor of the first card is connected to the interface of the second card through a switch allowing the second card to be checked by using commands transmitted by an external element to the first card and to the second card.

In one embodiment, the controlled elements comprise at least a fan, a probe, a filter or a power supply.

According to one embodiment, the processor of the first card presents a first UART port connected to the interface of the first card and a second UART port connected to the interface of the second card.

In one embodiment, the link between the processor of the first card and the interface of the second card is made by means of an RS232 link.

According to an embodiment, the interface of the second card comprises an IPMC controller.

In an embodiment, the second card is connected to the first card interface to enable the first card to be checked by using commands transmitted by the second card processor in the same manner as the checking of the second card by the first card interface.

The invention also relates to a process for managing a server for a telecommunication network comprising at least a first card and a second card equipped with elements managing transmissions from mobile terminals, this first card and second card each comprising a processor and an interface that may receive commands transmitted by an external controller to their card, characterized in that a server compliant with one of the previous embodiments is implemented so that the processor of the first card is connected to the interface of the second card and enables the second card to be checked by the processor of the first card.

Other characteristics and advantages of the invention will emerge clearly from the description given below, for indicative and in no way limiting purposes, with reference to the various attached figures that show:

In FIG. 1, already described, a schematic representation of a telecommunication server in conformance with the prior art, and

In FIG. 2 a schematic representation of a server in conformance with the invention.

With reference to FIG. 2, an “1+1” type server 20 is represented, presenting two unique cards 30 and 30′ associated in such a way that one card is active while the other card is passive, that is to say, on standby.

For example, card 30 is active and manages communications while card 30′ is kept waiting for a possible malfunction of card 30 to take over for it.

For this purpose, cards 30 use interface IPMC 22 to transmit operating parameters such as, for example, temperatures, states, alarms and/or voltages relative to a filter, a sensor and/or a fan of this card 30 to its processor 21.

To do this, a link 34 connects an internal port 24 of processor 21 with an internal port 25 of IPMC interface 22, this port 25 being referred to as a “serial payload” in the previously cited specifications.

Similarly, card 30′ presents a link 34′ connecting an internal port 24′ of its processor 21′ with an internal port 25′ of its IPMC interface 22′.

In conformance with this embodiment of the invention, the card 30′ utilizes its IPMC interface 22′ to communicate with processor 21 of card 30 and to transmit to the latter operating parameters such as, for example, temperatures, states and/or voltages relative to a filter, a sensor and/or a fan of this card 30′.

To do this, a link 33 connects an external port 23 of processor 21 with an external port 27′ of IPMC interface 22′ such that processor 21 may, according to the parameters transmitted by IMPMC interface 22′, control the operation of card 30′.

For this purpose, processor 21 may control the operation of card 22′ by means of IPMI control signals recognized by the IPMC interface 22′.

In this preferred embodiment, the invention is implemented with a reduced cost by using an external port 27′ existing in IMPC interface 22′, this port 27′ being referred to as a “serial debug” in the specifications that have already been mentioned.

This external port 27′ enables processor 21 to control the IPMC interface 22′ via a switch 26′, also enabling external element 28′ to control interface 22′, for example, to perform reprogramming of the card.

This is why switch 26′ presents an external link detector 37′ that, in case of activation, gives priority to the commands 36′ issued from external element 28′.

In addition, processor 21′ of card 30′ is connected to interface 22 of card 30 in the same way as the link between processor 21 of card 30 and interface 22′ of card 30′, which possibly allows checking of card 30 to be allowed by using commands transmitted by processor 21′ of card 30′.

In other words, the two cards 30 and 30′ are identical, an element X of card 30 thus presents an equivalent element noted X′ for card 30′, which enables the use of one or the other of cards 30 or 30′ as the active card in charge of controlling the other passive card.

As previously indicated, in this embodiment, card 30 is active such that its processor 21 controls both its operation and that of card 30′, for example to turn on, reprogram or turn off this card 30′ according to the temperature, voltage, state or alarm parameters that have already been mentioned.

In a practical manner, ports 23, 23′, 24 and 24′ are, in this embodiment, UART (Universal Asynchronous Receiver Transmitter) type serial ports.

These first ports are connected to respective ports 25, 25′, 27 or 27′, which are also UART ports, via links 33, 33′, 34 and 34′ such that RS232 links, suitable for serial transmission, enable the transmission and reception of data.

A server in compliance with the invention may particularly be implemented in the field of wireless telecommunications, for example of the WI-MAX or GSM type. In addition, it should be noted that such a server may be used within more complex equipment, for example in order to perform signal processing using the Internet Protocol, in a mobile telephony network.

1. A server for a telecommunications network comprising at least a first card and a second card equipped with elements managing transmissions transmitted or received by mobile terminals, this first card and this second card each comprising a processor and an interface configured to receive commands transmitted by an external controller to their card wherein the processor of the first card is connected to the interface of the second card to enable control of the second card by the processor of the first card.

2. The server according to claim 1 wherein the processor of the first card comprises means to activate the second card in case of malfunction of the first card and means to maintain on standby the second card in case of the correct operation of the first card.

3. The server according to claim 1 wherein the processor of the first card is connected to the interface of the second card through a switch enabling the second card to be checked by using commands transmitted by an external element to the first and to the second card

4. The server according to claim 1, wherein the controlled elements comprise at least a fan, a probe, a filter or a power supply.

5. The server according to claim 1 wherein the processor of the first card presents a first UART port connected to the interface of the first card and a second UART port connected to the interface of the second card.

6. The server according to claim 1 wherein the link between the processor of the first card and the interface of the second card is an RS232 connection.

7. The server according to claim 1 wherein the interface of the second card comprises an IPMC controller.

8. The server according to claim 1 wherein the processor of the second card is connected to the interface of the first card to enable the first card to be checked by using commands transmitted by the processor of the second card in the same way as the check of the second card by the processor of the first card.

9. A process for managing a server for a telecommunication network, this server comprising at least a first card and a second card equipped with elements managing the transmissions transmitted or received by the mobile terminals, each of this first card and this second card comprising a processor to control the operation of elements of this card from commands transmitted by an external element to the card and received by an interface of this latter, wherein the server is the server of claim 1 and is implemented in order to control the second card by using commands transmitted by the processor of the first card to the interface of the second card.
